(19) United States
(12) Patent Application Publication
(10) Pub. No.: US 2008/0143831 A1
(43) Pub. Date: Jun. 19, 2008

(54) SYSTEMS AND METHODS FOR USER NOTIFICATION IN A MULTI-USE ENVIRONMENT

(76) Inventors: Daniel David Bowen, West Jordan, UT (US); Jeremy Noring, Corvallis, OR (US); Grant A. Beckmann, Orem, UT (US); Thomas R. Rohlfing, Salt Lake City, UT (US)

Correspondence Address: BAKER & ASSOCIATES PLLC, 470 EAST NINTH AVENUE, SALT LAKE CITY, UT, 84103, US

(21) Appl. No.: 11/947,053

(22) Filed: Nov. 29, 2007

Related U.S. Application Data
(60) Provisional application No. 60/870,379, filed on Dec. 15, 2006.

(51) Int. Cl. H04N 7/18

(52) U.S. Cl. 348/143

(57) ABSTRACT

The present invention relates to systems and methods for notifying a user of a video monitoring system event while other video monitoring system related functions may be performed in the background of a multi-use computing environment. For example, a graphical pop-up, priority image, and/or notification sound may be transmitted to a user within a multi-use environment to alert the user that a particular video monitoring system related event has occurred. One embodiment of the present invention relates to a video monitoring system disposed within a multi-use computing and communication environment. The system includes a video input source, and a control module disposed within a multi-use computing environment. The control module includes a user notification system configured to continuously monitor the video data for local video monitoring related events and transmit a notification to a user of the multi-use computer system.

### RELATED APPLICATIONS

This application claims priority to U.S. provisional application Ser. No. 60/870,379 filed Dec. 15, 2006, the contents of which are incorporated by reference.

### FIELD OF THE INVENTION

The invention relates to video monitoring systems. In particular, the invention relates to systems and methods for notifying a user of a video monitoring system event in a multi-use environment.

### BACKGROUND OF THE INVENTION

Video monitoring systems are used to monitor video signals from one or more discrete locations or view angles. These systems are often used for security, surveillance, and personnel performance monitoring. Video monitoring systems generally include video capture devices, a control device, and a display. The video capture devices are one or more cameras configured to record video data at particular discrete locations. The control device is a computer or electronic module that receives the video data from each of the video capture devices and routes the signal to the display. The display converts the video data into a visually identifiable format. These components may be embedded into a personal computer or digital computer network, or they may incorporate portions of a computer network for purposes of data transmission and/or display.

One particular type of video monitoring system is one which utilizes a multi-use control device such as a personal computer, multi-media center, PDA, phone, etc. The multi-use device includes a multi-use environment which allows users to perform various tasks, including those related and unrelated to the video monitoring system. Non-video monitoring tasks may include local tasks such as word processing and distributed tasks such as internet browsing. Video monitoring system tasks include receiving video data from the video capture device and routing the video data to a display. Since the control device is used for various purposes, the processes relating to the video monitoring system are often run “in the background” or “hidden” from a user. While this allows a user to efficiently perform tasks in a multi-use environment, it often impedes a user's ability to react to events occurring in the video monitoring system. For example, a user may not see a particular video security violation event if he/she is performing an alternative visual function with the control device, such as viewing an internet browser.

Users of a video monitoring system may wish to display and affect aspects of the system from a remote multi-use device that is not necessarily within the scope of the local data transmission system used to transfer video data from the video capture devices to the control device. Therefore, the control device may also be coupled to a wide area network (WAN) or global network for purposes of remote data viewing and system manipulation. Remote users will also likely wish to display aspects of the system on a multi-use device and therefore may not be able to properly react to video monitoring system events.

Therefore, there is a need in the video data monitoring industry for systems and methods that enable a multi-use control device while properly enabling a user to be aware of important events related to the video monitoring system.

### SUMMARY OF THE INVENTION

The present invention relates to systems and methods for notifying a user of a video monitoring system event while other video monitoring system related functions may be performed in the background of a multi-use computing environment. For example, a graphical pop-up, priority image, and/or notification sound may be transmitted to a user within a multi-use environment to alert the user that a particular video monitoring system related event has occurred. These video monitoring system related events may include both control-type events and video content-type events. One embodiment of the present invention relates to a video monitoring system disposed within a multi-use computing and communication environment. The system includes a video input source and a control module disposed within a multi-use computing environment. The control module includes a user notification system configured to continuously monitor the video data for local video monitoring related events and transmit a notification to a user of the multi-use computer system. The notification includes user sensory feedback within the foreground of the multi-use computing environment irrespective of whether the control module is disposed within the background or foreground of the multi-use computing environment. Alternatively and/or in addition, the control module may be further data coupled to a remote client module disposed within a remote multi-use computing environment. The user notification system may be selectively configured to further transmit a remote notification to a user of the remote client module including a user sensory feedback within the foreground of the remote multi-use computing environment. A further embodiment relates to a video monitoring system control module software method for notifying a user of video monitoring system related events from the background of a multi-use computing environment. Alternatively, the method may further include notifying a remote user of a local video monitoring system event within a remote multi-use computing environment.

Embodiments of the present invention represent a significant advance in the field of video monitoring systems. Conventional video monitoring systems are often inefficiently disposed in single use computing environments to provide constant sensory feedback of events. Improved video monitoring systems are able to be disposed within multi-use computing environments but are often ineffective at alerting use if disposed within the background. Therefore, embodiments of the present invention enable user notifications to be transmitted to a user in the form of user sensory feedback when disposed within the background of the multi-use computing environment. Therefore, users are able to maximize sensory resources by performing non-video monitoring related tasks on the multi-use computing environment and only notified by the video monitoring system if a particular event occurs.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the system according to the invention. In the Figures, the physical dimensions may be exaggerated for clarity.

FIG. 1 illustrates a flow chart of a suitable computer operating environment for embodiments of the present invention;

FIG. 2 illustrates a schematic view of a computer controlled distributed multiple video monitoring system, which may be used in conjunction with embodiments of the present invention;

FIG. 3 illustrates a schematic of a local video monitoring system including a control module disposed within a multi-use computing environment in accordance with embodiments of the present invention;

FIG. 4 illustrates a data communication chart detailing one embodiment of communication structure between the notification system of the video monitoring system and two remote clients in accordance with embodiments of the present invention;

FIG. 5 illustrates a remote client Windows Media Center type multi-use computing environment including a notification about a local video monitoring system event in accordance with embodiments of the present invention; and

FIG. 6 illustrates a notification window about a video monitoring system related event in accordance with embodiments of the present invention;

FIG. 7 illustrates a video monitoring system notification interface to enable a user to configure a notification system in a multi-use computing environment in accordance with embodiments of the present invention.

### DETAILED DESCRIPTION OF THE INVENTION

The present invention relates to systems and methods for notifying a user of a video monitoring system event while other video monitoring system related functions may be performed in the background of a multi-use computing environment. For example, a graphical pop-up, priority image, and/or notification sound may be transmitted to a user within a multi-use environment to alert the user that a particular video monitoring system related event has occurred. These video monitoring system related events may include both control-type events and video content—type events. One embodiment of the present invention relates to a video monitoring system disposed within a multi-use computing and communication environment. The system includes a video input source and a control module disposed within a multi-use computing environment. The control module includes a user notification system configured to continuously monitor the video data for local video monitoring related events and transmit a notification to a user of the multi-use computer system. The notification includes user sensory feedback within the foreground of the multi-use computing environment irrespective of whether the control module is disposed within the background or foreground of the multi-use computing environment. Alternatively and/or in addition, the control module may be further data coupled to a remote client module disposed within a remote multi-use computing environment. The user notification system may be selectively configured to further transmit a remote notification to a user of the remote client module including a user sensory feedback within the foreground of the remote multi-use computing environment. A further embodiment relates to a video monitoring system control module software method for notifying a user of video monitoring system related events from the background of a multi-use computing environment. Alternatively, the method may further include notifying a remote user of a local video monitoring system event within a remote multi-use computing environment. While embodiments of present invention are described in reference to systems and methods for notifying a user of a video monitoring system event in a multi-use computing environment, it will be appreciated that the teachings of present invention are applicable to other areas.

The following terms are defined as follows:

Multi-use computing environment—an operating environment of a computing system that may be utilized for a variety of independent and/or simultaneous tasks/applications. For example, a computer device such as a personal desktop computer includes an operating system environment which may simultaneously perform various tasks, including controlling a video monitoring system and operating a word processing application. Likewise, various other systems may be referred to as including a multi-use computing environment including but not limited to a cell phone, a PDA, a laptop, a multi-media player, etc.

Foreground—an operating sub-environment of a multi-use computing environment in which tasks include a corresponding user sensory feedback.

Background—an operating sub-environment of a multi-use computing environment in which tasks do include a corresponding user sensory feedback.

User Sensory Feedback—an output transmitted to a user by a computing system via at least one human sensory channel including visual, audible, tactile, olfactory, and gustatory.

Video monitoring system—a system for location-based monitoring for purposes including surveillance, monitoring, and personnel performance. The system includes at least one video capture devices and a control module.

Video monitoring system related event—An event related to a video monitoring system. Video monitoring system related events may include both control related events and video content related events. Control related events may include discovering new video capture device, malfunction of video capture device, presence of a remote client, etc. Video content related events may include detected motion, specific video/image recognition, daylight, etc.

Local data transmission system—a data transmission system for transferring data between components within a confined region. For example, a local Ethernet, power line computer network, wireless network, or analog or digital wired or wireless transmission systems.

Global data transmission system—a data transmission system for transferring data between distributed components within a geographically large area. For example, the Internet enables data transmission between distributed components. A global data transmission system is defined broadly to include a local data transmission system.

Control module—a computer and/or electrical component of a video monitoring system for receiving, transmitting, displaying video data, controlling video devices, and facilitating communication with attached video devices.

Client module—a computer and/or electrical component coupled to a video monitoring system to enable a remote user to view video data. A client module may be disposed within a multi-use computing environment or a dedicated computing

The following disclosure of the present invention is grouped into two subheadings, namely “Operating Environment” and “User Notification in a Multi-use Environment”. The utilization of the subheadings is for convenience of the reader only and is not to be construed as limiting in any sense.

### Operating Environment

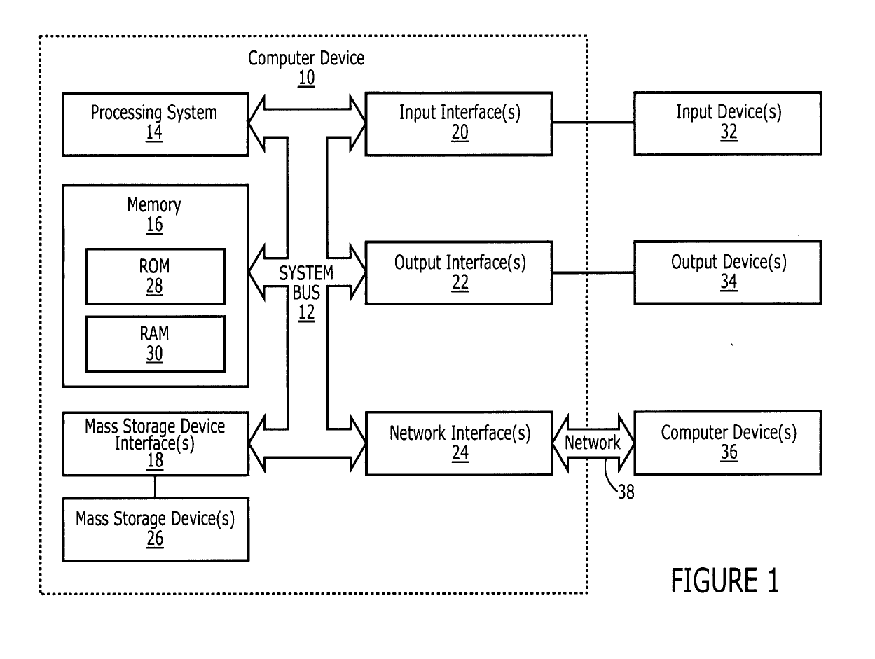

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), smart phone, or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Remote Video Monitoring System

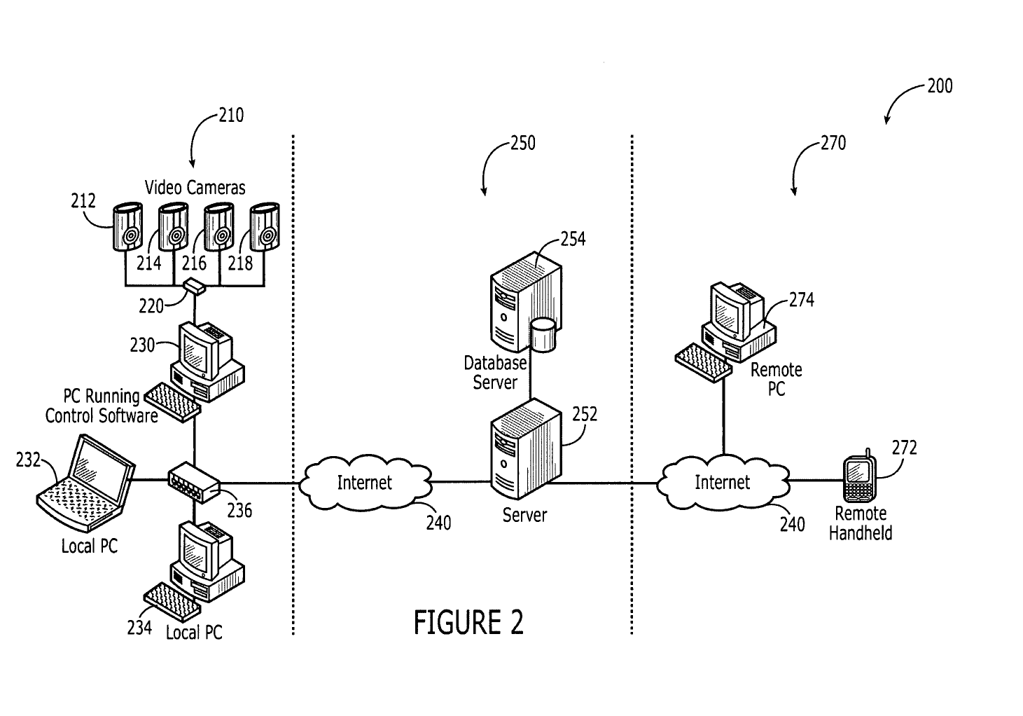

Reference is next made to FIG. 2, which illustrates a schematic view of a computer controlled distributed multiple video monitoring system, designated generally at 200. The illustrated system 200 architecture is an example of one type of video monitoring system in which embodiments of the present invention may be utilized. Various components of the illustrated system will be further described for purposes of reference to the embodiments of the present invention. It will be appreciated that embodiments of the present invention may be utilized with other alternative distributed video monitoring system architectures. The illustrated system 200 includes a local computer controlled video monitoring/surveillance system 210, a distributed data processing system 250, and a remote client system 270. The systems 210, 250, 270 are coupled via the Internet 240 acting as a global data transmission system. As is well known in the industry, various components may be further distributed or geographically consolidated for purposes of utilizing hardware and/or data coupling resources.

The computer controlled video monitoring system 210 includes a plurality of video capture devices 212, 214, 216, 218, a video router 220, a control module 230, a local laptop client 232, a local pc client 234, and a local network router 236. The video capture devices 212, 214, 216, 218 are digital video cameras configured to capture video data of a particular location and generate a video data signal that includes graphical sequential images of the particular location. One type of digital video capture device is a WILIFE® brand camera. The video capture devices 212, 214, 216, 218 are data coupled to the control module 230 via a video router 220. The video router 220 is an optional component and may be any type of data converter, multiplexer, or router such as a USB power line data converter or Ethernet data converter. For example, the video capture devices 212, 214, 216, 218 may be coupled to a power line network such as a HOMEPLUG type system in which a USB data converter allows the control module 230 to receive the video data signal from all of the video capture devices 212, 214, 216, 218 across the power line. The video capture devices 212, 214, 216, 218 may include a variety of different types of devices including but not limited to analog, digital, wireless, wired, panable, fixed, indoor, outdoor, discrete, spy, mobile, etc. The control module 230 is a multi-use personal computer running a software module configured to receive and process the video data signals from the video capture devices 212, 214, 216, 218. For example, the software module may be a WILIFE® brand program. The control module 230 may perform other tasks in addition to managing the video data signals utilizing a well known multiprocessing operating system such as Microsoft WINDOWS®. The control module 230 may be configured to record, display, alert, or transmit data corresponding to the video data signals from the video capture devices 212, 214, 216, 218. The local laptop client 232 and local pc client 234 are data coupled to control module 230 via an optional network router 236 such as an Ethernet wired router or wireless 802.11 type data router. Various other local network architectures may be utilized to distribute the video data signals among the local clients 232, 234 and between the video capture devices 212, 214, 216, 218, and the control module 230.

The computer controlled video monitoring system 210 is coupled to the distributed data processing system 250 via the Internet 240. The distributed data processing system 250 includes a database server 254 and a server 252. The database server 254 may be configured to store video data from one or more computer-controlled video monitoring systems 210, authentication information, account information, etc. The server 252 may be used to facilitate routing video data from the computer controlled video monitoring system 210 to the remote client system 270. For example, the illustrated server 252 and database server 254 may authenticate a user on the remote client system 270 and transmit the appropriate one or more requested video data signals from the corresponding computer controlled video monitoring system 210. Various other management and storage type functions may be performed by the distributed data processing system 250. In an alternative data processing configuration, data signals from the computer controlled video monitoring system 210 may be routed directly to the remote client system 270 without the data processing system 250. Depending on various communication parameters, the use of intermediary data routing, authentication, and/or processing through the distributed data processing system 250 is optional.

The remote client system 270 includes a remote client pc 274 and a remote client handheld 272, both data coupled to the Internet 240. The remote clients 272, 274 may display one or more video data signals from the video capture devices 212, 214, 216, 218 of the computer controlled video monitoring system 210. In particular, the remote clients 272, 274 may select to view the multiple video data signals individually, simultaneously, or intermittently. The remote clients 272, 274 may also interface with the distributed data processing system 250 for purposes of authentication, data routing, electronic payment, management, etc. The remote clients 272, 274 may be coupled to the Internet 240 utilizing various well known connection schemes including but not limited to cellular phone data networks, local computing data networks, etc. The remote clients 272, 274 may interface and/or receive the video data signals from a web browser or directly within a particular local software module. Likewise, the remote clients 272, 274 may receive email attachments corresponding to data from the computer controlled video monitoring system 210.

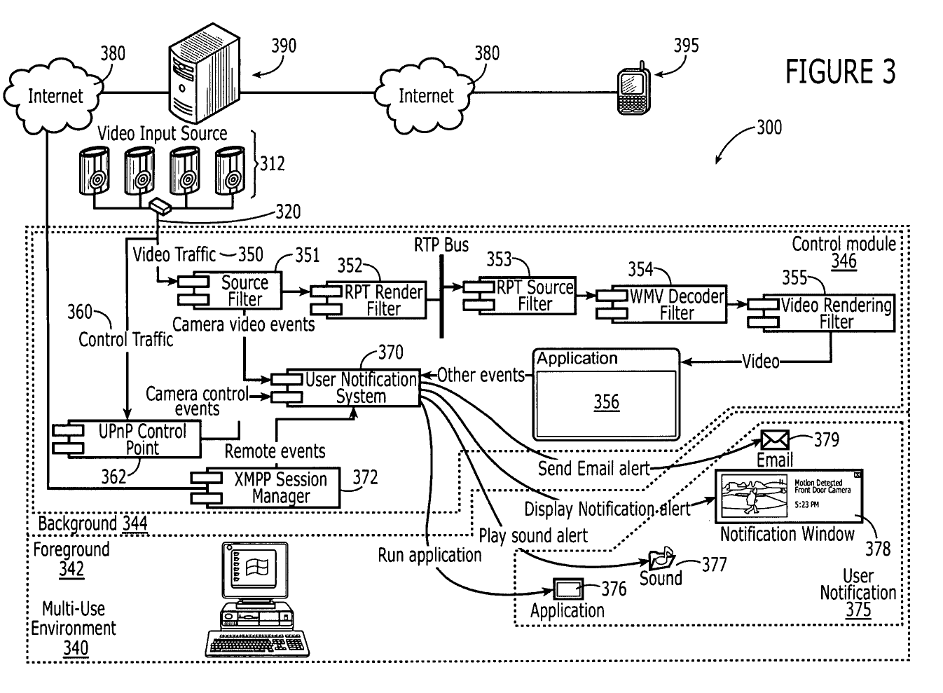

Reference is next made to FIG. 3, which illustrates a schematic of a local video monitoring system including a control module disposed within a multi-use computing environment, designated generally at 300. It will be appreciated that numerous alternative communication and process module architectures may be implemented to perform the notification functions described in accordance with the present invention. The system 300 includes a multi-use computing environment 340 of a computing device within which a control module 346 is disposed. The multi-use computing environment 340 is schematically broken into a background 344 and a foreground 342 representing sub-environments within which tasks are performed. The background 344 of the multi-use computing environment 340 represents a sub-environment within which tasks are performed without corresponding user sensory feedback. For example, applications which are “minimized” in a conventional personal computer operating system may be said to be operating in the background because they are no longer transmitting visual feedback to the users corresponding to their operation. The foreground 342 of the multi-use computing environment 340 represents a sub-environment within which tasks are performed with corresponding sensory feedback. For example, applications which are “maximized” in a convention personal computer operating environment include at least a visual display corresponding to their operation. The control module 346 is disposed within the background 344 of the multi-use computing environment 340 thereby allowing a user of the multi-use computing environment 340 to maximize their sensory resources on alternative tasks. For example, a user may watch a DVD movie through the multi-use computing environment 340 including both visual and audible sensory transmissions while the tasks associated with the control module are performed without corresponding user sensory feedback. A user notification 375 transmission from the control module 346 is illustrated within the foreground 342 of the multi-use computing environment 340 such that at least one sensory transmission is made to the user notifying them of a video monitoring system related event. For example, while a user is watching a movie (not illustrated) in the foreground 342, an additional sensory transmission from the user notification 375 is made despite the control module 346 being disposed within the background 344.

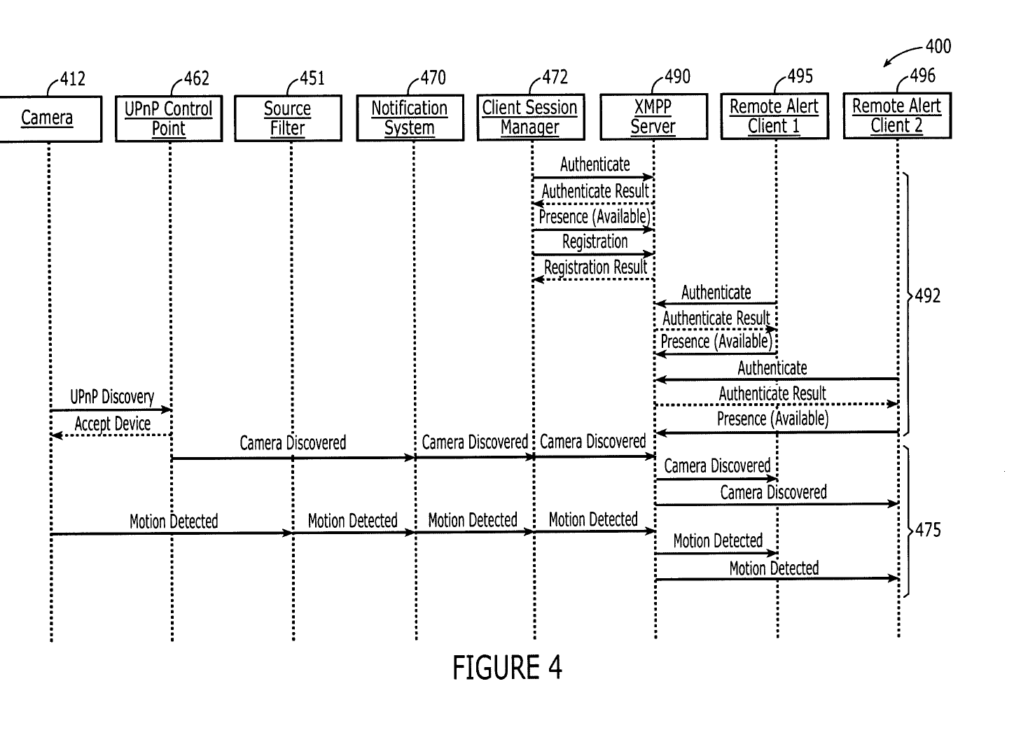

The system 300 further includes coupling the control module 346 to a video input source 312 via a local data transmission system 320 and to a global data transmission system 380. As discussed above, with reference to FIG. 2 and the video monitoring system 210, the video input sources 312 capture video data and transmit a video data signal. Although illustrated as four video capture devices, embodiments of the present invention are directly applicable to systems including one video capture device. It will further be appreciated that any single video capture device may be utilized in accordance with embodiments of the present invention. The illustrated global data transmission system is the Internet. The control module 346 is further coupled to a communication server 390 and a remote client 395 via the global data transmission system 380. As discussed above with reference to FIG. 2, this particular data coupling facilitates the distributed functionality of the video monitoring system 300. Embodiments of the present invention include transmitting remote user notifications to the remote client 395. One example of a communication scheme for transmitting user notifications to a remote client is illustrated and described with reference to FIG. 4.

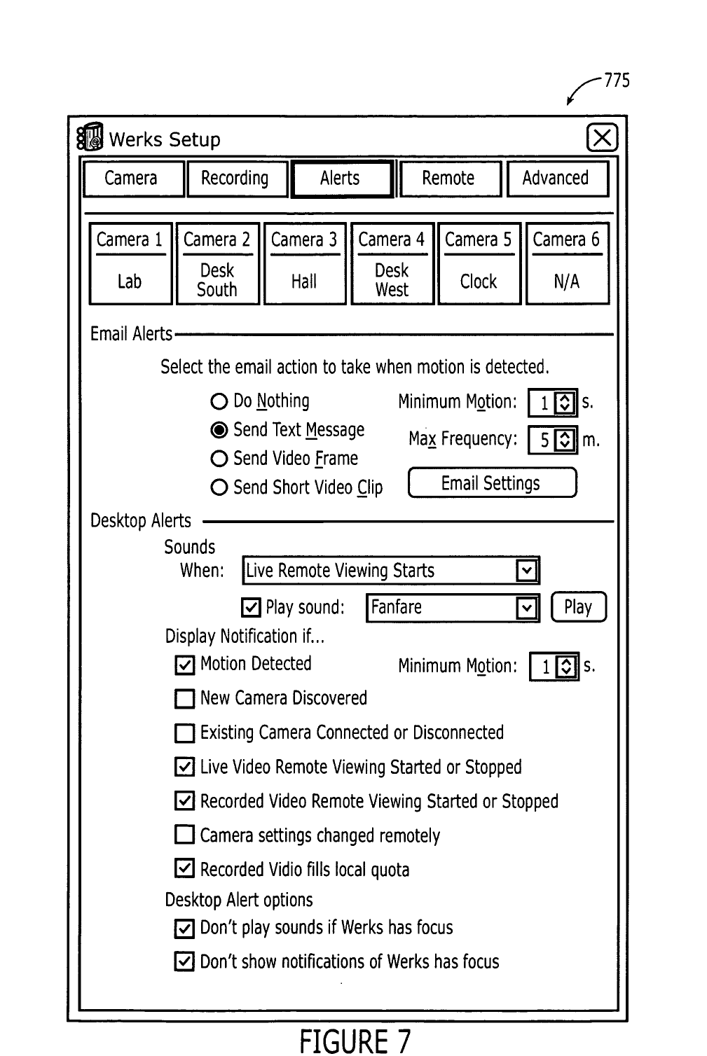

The control module 346 includes a user notification system 370 and a plurality of modules facilitating the video data signal processing associated with other functions of the video monitoring system 300. It will be appreciated that various architectures and sub-modules may be used to perform the non-user notification tasks of the video monitoring system 300. It will also be appreciated that the user notification system 370 may be selectively configured to identify or ignore various video monitoring system related events. One example of a video monitoring system configuration interface is illustrated and described with reference to FIG. 7. In the illustrated embodiment, the video data signal(s) is received by the control module 346. The video traffic 350 may be separately routed from the control traffic 360 by various well known data packaging and/or multiplexing techniques such as specific location serial encoding. The video traffic 350 represents the video content data of the video data signal corresponding to the streaming captured video image corresponding to the video input source(s) 312. The control traffic 360 corresponds to control related functions such as the status or presence of one or more of the video capture devices. The control traffic 360 is decoded for identifying video monitoring system events and transmitted to the user notification system 370. The video traffic 350 is routed through at least one filter to facilitate processing the data for purposes of user notification and/or the operation of the video monitoring system application 356. The source filter 351 identifies particular camera video events such as the detection of motion and directly routes the corresponding video traffic 350 to the user notification system 351. Alternatively, the video traffic 350 is routed through a RTP render filter 352, RTP source filter 353, WMV decoder filter 354, and video rendering filter 355 before being compiled within the application 356 of the video monitoring system 300. Since the control module 346 is in the background 344, the application 356 is not visible to a user. The application 356 may also be referred to as the interface and be configured to notify a user of other events. Therefore, the video traffic 350 may be transmitted from the application/interface to the user notification system 370.

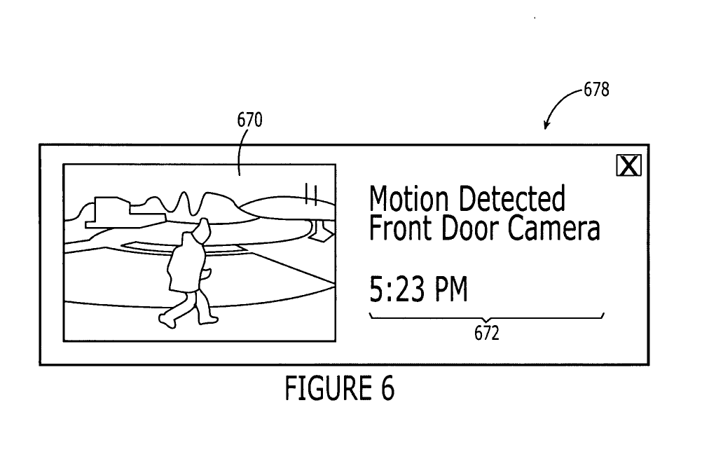

The user notification system 370 operates to notify a user of the multi-use environment of a video monitoring system related event regardless of whether the control module 346 is disposed within the background 344. As described above, video traffic 350 and control traffic 360 are routed to the user notification system 370. Depending on various parameters, the user notification system 370 generates a user notification 375 in the foreground 342 of the multi-use environment 340 to alert the user of the video monitoring system related event. The illustrated user notification 375 block includes four alternative notification schemes, which may be used independently or in conjunction to provide a user sensory feedback to the user of the multi-use computing environment 340. The schemes include an email message 379, a notification window 378, a sound 377, and an application 376, which may each produce an instantaneous visual and/or audible sensory feedback alert to the user. Various data corresponding to the video monitoring system related event may be included within the particular notification scheme. For example, the email message 379 may include video, photo, and or textual informational content corresponding to a particular video monitoring system related event. A detailed discussion of a user notification window 378 is included below with reference to FIG. 6.

The user notification system 370 may further be configured to notify a remote user of the remote client 395 of a video monitoring system related event. The remote client 395 may also be a multi-use computing environment such as a computing operating system. For example, WINDOWS MOBILE is a well known multi-use computing environment utilized in portable handheld computing devices. The user notification system 370 is coupled to a session manager 372 and a server 390 to facilitate a particular type of data communication with the remote client 395, so as to produce a user notification in the foreground of the remote client's multi-use computing system. Please refer to the descriptions associated with FIGS. 2 and 4 to illustrate one example of an architecture and communication scheme to facilitate the remote user notification in accordance with embodiments of the present invention.

Reference is next made to FIG. 4, which illustrates a data communication chart detailing one embodiment of communication structure between the notification system of the video monitoring system and two remote clients, designated generally at 400. The system 400 communication schematic includes a camera 412 (video capture device), a UPnP control point 462, a source filter 451, a user notification system 470, a client session manager 472, a XMPP server 490, a first remote client 495, and a second remote client 496. It will be noted that reference numbers are designated in a manner to facilitate correspondence with other figures whenever possible to facilitate readability. However, no limitations or associations may be assumed in reference to the particular reference numbering. The system 400 illustrates an authentication/registration process for both of the remote clients designated generally at 492. The particular communication scheme between the components to facilitate the remote client notification is separately illustrated and designated generally at 475.

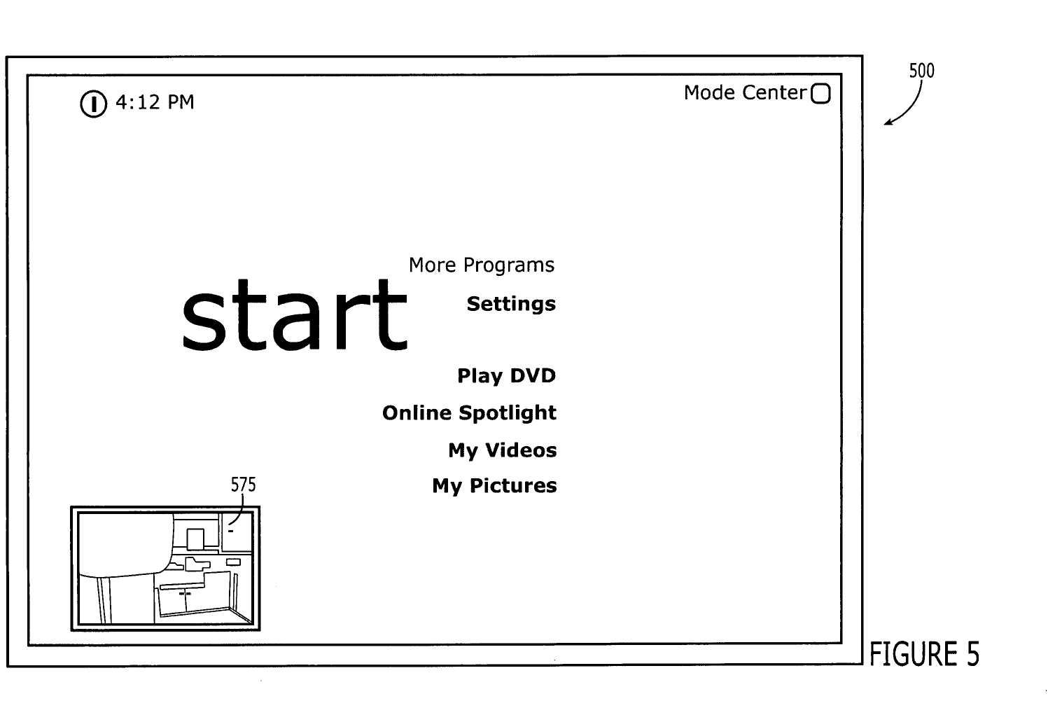

Reference is next made to FIG. 5, which illustrates a remote client Windows Media Center type multi-use computing environment, including a notification about a local video monitoring system event, designated generally at 500. The illustrated windows media center multi-use computing environment may house the control module of the video monitoring system or may be a remote client of the video monitoring system depending on a particular implementation. The illustrated representation of the multi-use computing environment 500 includes both a selective media interface and a user notification 575. The selective media interface allows a user to selectively play and/or configure various media related functions. The user notification 575 is a visual graphical notification alerting a user of a particular video monitoring system related event through a user sensory feedback. The illustrated user notification 575 notifies the user of detected motion in a particular office through a live video representation of the video traffic from the corresponding video capture device. The user notification 575 is two dimensionally sized less than fifty percent of the available display region of the multi-use computing environment. In addition, although not illustrated, the user notification 575 is temporarily displayed for a period of time less than thirty seconds. As is well known in the industry, a similar media environment may be displayed on a television, projector, monitor, etc. to facilitate the illustrated multi-use computing environment.

Reference is next made to FIG. 6, which illustrates a notification window about a video monitoring system related event, designated generally at 600. The illustrated notification window 600 includes multiple visual sensory feedback for a user relating to a corresponding video monitoring system related event. The notification window 600 includes an image 670 from the video traffic corresponding to the event, a textual description of the particular event, and the time of the particular event. The notification window 600 is a dialog box of a computing operative system such that a user may selectively close the dialog box after receiving the contained information. Likewise, it will be appreciated that various other characteristics of the dialog box may be incorporated such as transparency, temporary timing, particular visual positioning, etc.

Reference is next made to FIG. 7, which illustrates a video monitoring system notification interface to enable a user to configure a notification system in a multi-use computing environment, designated generally at 700. The interface 700 includes an example of various user selectable variables which may control the functionality of a user notification system 370 such as the one illustrated in FIG. 3. The parameters relate to the particular video monitoring system related events that may trigger a user notification and the format and content of the associated user notification. As illustrated, individual settings may be applied for individual video capture devices.

Various other embodiments have been contemplated, including combinations in whole or in part of the embodiments described above.

What is claimed is:

1. A video monitoring system disposed within a multi-use computing and communication environment, comprising:
a local data transmission system;
a video input source, wherein the video input source includes a video capture device configured to create a video data signal, and wherein the video input source is coupled to the local data transmission system;
a control module data coupled to the video input source via the local data transmission system so as to receive the video data signal, wherein the control module is disposed within a multi-use computing environment on which various modules are selectively executed in one of a foreground and background, wherein the foreground of the multi-use computer environment includes executing tasks in conjunction with corresponding user sensory feedback, and wherein the background includes executing tasks without corresponding user sensory feedback; and
wherein the control module further includes a user notification system configured to continuously monitor the video data signal for local video monitoring related events and notify a user of the multi-use computing environment of a local video monitoring related event within the foreground when the control module is in either one of the foreground and background of the multi-use computing environment.

2. The system of claim 1, wherein the local data transmission system is a multi-use communication medium across which both video related and non-video related data is transmitted.

3. The system of claim 1, wherein the video input source includes a plurality of video input sources and corresponding video data signals.

4. The system of claim 1, wherein the control module is a computer software module, and wherein the multi-use computing environment is a computing operating system within which tasks are performed in one of the foreground and background.

5. The system of claim 4, wherein the computing operating system is a WINDOWS® based computing operating system.

6. The system of claim 1, wherein the user notification system includes a plurality of selectively executable notification schemes configured to alert a user via at least one user sensory feedback including visual and audible.

7. The system of claim 6, wherein the plurality of selectively executable notification schemes includes a notification window, wherein the notification window is visually displayed in the foreground for a period of time less than thirty seconds, and wherein the notification window is two dimensionally sized less than fifty percent of an available two dimensional display region, and wherein the notification window includes a display of information corresponding to the local video monitoring related event.

8. The system of claim 7, wherein the notification window further includes a graphical image corresponding to the local video monitoring related event.

9. The system of claim 1, wherein the control module includes at least one filter through which the video data signal is routed to the user notification system.

10. The system of claim 1, wherein the user notification system is data coupled to a communication server via a global data transmission system, and wherein the communication server is data coupled to a remote client via the global data transmission system, and wherein the user notification system is further configured to transmit a remote notification to a user of the remote client of a local video monitoring related event, wherein the remote notification includes a user sensory feedback transmitted within a foreground of the remote client.

11. A video monitoring system control module software method for notifying a user of video monitoring system related events from the background of a multi-use computing environment, comprising the acts of:
providing a video monitoring system control module disposed within a background of a multi-use computing environment;
receiving a video data signal across a local data transmission system, wherein the video data signal corresponds to video data captured at a specific location and orientation by a video capture device;
identifying video monitoring system events within the video data signal; and
alerting a user of the multi-use computing environment of the video monitoring system events including transmitting a user sensory feedback notification within the foreground of the multi-use computing environment.

12. The method of claim 11, wherein the act of receiving a video data signal across a local data transmission system includes coupling the video capture device to the local data transmission system and coupling the multi-use computing environment to the local data transmission system.

13. The method of claim 11, wherein the act of identifying video monitoring system events within the video data signal includes identifying control events by the video capture device and events identified through filtering the video data signal generated by the video capture device.

14. The method of claim 11, wherein the act of alerting a user of the multi-use computing environment of the video monitoring system events includes displaying a notification window in the foreground of the multi-use computing environment.

15. The method of claim 14, wherein the notification window includes a graphical representation of the content of the video monitoring system event.

16. The method of claim 11, wherein the act of alerting a user of the multi-use computing environment of the video monitoring system events includes audibly transmitting a notification sound in the foreground of the multi-use computing environment.

17. The method of claim 16, wherein the notification sound specifically includes a unique audible noise corresponding to the content of the video monitoring system event.

18. A remotely accessible video monitoring system disposed within a multi-use computing and communication environment comprising:
a local data transmission system;
a global data transmission system;
a video input source, wherein the video input source includes a video capture device configured to create a video data signal, and wherein the video input source is coupled to the local data transmission system;
a control module data coupled to the video input source via the local data transmission system so as to receive the video data signal, wherein the control module is data coupled to the global data transmission system;
a client module data coupled to the control module via the global data transmission system, wherein the client module is disposed within a remote multi-use computing environment on which various modules are selectively executed in one of a foreground and background, wherein the foreground of the remote multi-use computer environment includes executing tasks in conjunction with user sensory feedback, and wherein the background includes executing tasks without user sensory feedback; and
wherein the control module further includes a user notification system configured to continuously monitor the video data signal for local video monitoring related events and transmit a notification to a remote user of the client module of a local video monitoring related event within the foreground of the remote multi-use environment via the global data transmission system.

19. The system of claim 18, wherein the user notification system includes a plurality of selectively executable notification schemes configured to alert a user via at least one user sensory feedback including visual and audible.

20. The system of claim 18, wherein the control module is disposed within the background of a multi-use computing environment on which various modules are selectively executed in one of a foreground and background, wherein the foreground of the multi-use computer environment includes executing tasks in conjunction with corresponding user sensory feedback, and wherein the background includes executing tasks without corresponding user sensory feedback.
